(19) United States
(12) Patent Application Publication
(10) Pub. No.: US 2015/0088089 A1
(43) Pub. Date: Mar. 26, 2015

(54) RECONSTITUTION DEVICE

(71) Applicant: GLUCAGO, LLC, El Segundo, CA (US)

(72) Inventors: Rush L. Bartlett, II, Mountain View, CA (US); Peter M. Greco, Fishers, IN (US); Kevin D. Predmore, Heath, OH (US); Brian C. Kelley, Pataskala, OH (US); Joseph D. Dennis, Grandview Heights, OH (US); Christopher P. McKenzie, Lancaster, OH (US)

(21) Appl. No.: 14/395,018

(22) PCT Filed: Apr. 26, 2013
(86) PCT No.: PCT/US13/38490

§ 371 Date: Oct. 16, 2014

Related U.S. Application Data
(60) Provisional application No. 61/639,596, filed on Apr. 27, 2012.
(60) Provisional application No. 61/645,976, filed on May 11, 2012.

(51) Int. Cl. A61J 1/20; A61J 1/06

(52) U.S. Cl. CPC A61J 1/2093; A61J 1/062
USPC 604/403

(57) ABSTRACT

An apparatus (10) includes a body (2), a plunger (5), and an occlusion (4). The body is able to hold one or more medical substances therein. The body defines a longitudinal axis extending therethrough. The plunger is positioned within a portion of the body and is able to axially advance along the longitudinal axis. The plunger also defines an opening extending therethrough. The occlusion is able to extend through at least a portion of the opening of the plunger so that the plunger and the occlusion fluidly divide the body. The plunger is able to exert a first outward force against the body. The plunger is able to exert a second outward force against the body when the occlusion has been removed where the second outward force is less than the first outward force.

### PRIORITY

This application claims priority to U.S. Provisional Patent Application Ser. No. 61/645,976, filed May 11, 2012, entitled “Reconstitution Device,” and to U.S. Provisional Patent Application Ser. No. 61/639,596, filed Apr. 27, 2012, entitled “Reconstitution Device,” the disclosures of which are incorporated by reference herein.

### BACKGROUND

Many drugs must be stored independent of another substance (another drug or a diluent) and then mixed together in order to be administered to the patient. This administration could take place through the oral, intravenous, intradermal, intramuscular, subcutaneous, mucus membrane, skin contacting, or inhalation routes to enter the body although this is not an exhaustive list. These medications may comprise a combination of a solid and a liquid, or a liquid with another liquid. These solid drugs mixed with a liquid or liquid drugs mixed with another liquid are used for treatment in a variety of applications including but not limited to vaccination, diagnostic agents, therapeutics, pharmaceuticals, controlled release formulations, polymer drug conjugates, liposomes, gene therapy agents, DNA, RNA, proteins, peptides, small molecules, large molecules, and many others.

Currently there are only a few methods of administration that facilitate this mixing process of a solid and liquid or a liquid and liquid. The main device categories include: needle spikes, needless adaptors, three way valves, glass syringes with a bypass built into the glass, and more complex devices that facilitate medication transfer between two containers. The devices currently on the market either are difficult to use but low cost or alternatively are high cost and easier to use. Similarly, all of the options that use standard filling to facilitate a safer and easier reconstitution process only facilitate liquid transfer external to standard containers via spikes or connectors attached externally to a standard container. At the other end of the spectrum, easier to use options do not use standard manufacturing processes to fill and or lyophilize the material.

While a variety of reconstitution devices have been made and used, it is believed that no one prior to the inventor(s) has made or used an invention as described herein.

### BRIEF DESCRIPTION OF THE DRAWINGS

It is believed the present invention will be better understood from the following description of certain examples taken in conjunction with the accompanying drawings, in which like reference numerals identify the same elements and in which:

FIG. 1 depicts a perspective cross sectional view of an exemplary reconstitution device;

FIG. 2 depicts a perspective cross sectional view of the reconstitution device of FIG. 1, with a plug axially advanced;

FIG. 3 depicts a perspective cross sectional view of the reconstitution device of FIG. 1, with a plunger axially advanced;

FIG. 4 depicts a perspective cross sectional view of the reconstitution device of FIG. 1, with the plunger further axially advanced;

FIG. 5 depicts a cross sectional elevation view of another merely exemplary reconstitution device;

FIG. 6 depicts a cross sectional elevation view of the container, seal rod, and stoppers of the reconstitution device of FIG. 5;

FIG. 7 depicts a cross sectional elevation view of the container of FIG. 6 receiving a drug;

FIG. 8 depicts a cross sectional elevation view of the container of FIG. 6 receiving a stopper to seal the container;

FIG. 9 depicts a cross sectional elevation view of the container of FIG. 6 with the container sealed;

FIG. 10 depicts a cross sectional elevation view of the container of FIG. 6 in a holder device;

FIG. 11 depicts a cross sectional elevation view of the reconstitution device of FIG. 5 with a fluid added to the diluent container;

FIG. 12 depicts a cross sectional elevation view of the reconstitution device of FIG. 5 with a stopper and crimp member applied;

FIG. 13 depicts a cross sectional elevation view of the reconstitution device of FIG. 5 with the seal rod retracted;

FIG. 14 depicts a cross sectional elevation view of the reconstitution device of FIG. 5 with the drug component undergoing reconstitution;

FIG. 15 depicts a cross sectional elevation view of the reconstitution device of FIG. 5 with the reconstitution device flipped over;

FIG. 16 depicts a cross sectional elevation view of the reconstitution device of FIG. 5 with the drug component being advanced through the diluent container;

FIG. 17 depicts a cross sectional elevation view of the reconstitution device of FIG. 5 with the drug component being advanced further through the diluent container and out the dispensing port;

FIG. 18 depicts a cross sectional elevation view of the reconstitution device of FIG. 5 with the drug component being advanced fully through the diluent container and completely out the dispensing port;

FIG. 19 depicts a cross sectional perspective view of another exemplary version of a reconstitution device;

FIG. 20 depicts a cross sectional perspective view of the reconstitution device of FIG. 19 having a plug slightly retracted;

FIG. 21 depicts a cross sectional perspective view of the reconstitution device of FIG. 19 having a diluent plunger advanced;

FIG. 22 depicts a cross sectional perspective view of the reconstitution device of FIG. 19 having the plug reseated;

FIG. 23 depicts a cross sectional perspective view of the reconstitution device of FIG. 19 advancing the plug and a ring plunger;

FIG. 24 depicts a side cross sectional perspective view of the reconstitution device of FIG. 19 having a variation of a mechanism for connecting a cartridge and a diluent container;

FIG. 25 depicts a cross sectional perspective view of the reconstitution device of FIG. 19 showing the cartridge; and

FIG. 26 depicts a cross sectional perspective view of the reconstitution device of FIG. 19 in a particular fill configuration.

The drawings are not intended to be limiting in any way, and it is contemplated that various embodiments of the invention may be carried out in a variety of other ways, including those not necessarily depicted in the drawings. The accompanying drawings incorporated in and forming a part of the specification illustrate several aspects of the present invention, and together with the description serve to explain the principles of the invention; it being understood, however, that this invention is not limited to the precise arrangements shown.

### SUMMARY

The disclosed device may facilitate the storage of two substances independent of each other and upon activation, introduce the two creating a solution. This device may then facilitate the dispensing of the resulting solution. The device may be used both for solid (lyophilized, spray dried or other) drugs to be mixed with a liquid, or two liquids (one or both being drugs). The disclosed device could be used with lyophilized materials and a diluent but the device disclosed may also facilitate mixing of two liquids, a spray dried compound and a liquid, a precipitated solid and a liquid, a semi solid or colloid and a liquid, or any combination of a liquid and any other substance as would be apparent to one of ordinary skill in the art in view of the teachings herein. Also, it should be noted that multiple disclosed containers with reconstitution components could be attached or added together to facilitate mixing of more than two components. Additional configurations containing more than two separate compartments, vials, chambers, or containers will be apparent to one of ordinary skill in the art in view of the teachings herein.

Currently disclosed are three merely exemplary devices having separation components that allow for flow through the components to facilitate mixing upon activation by some outside force. This force could include pressure, temperature, gravity, or outside mechanical intervention by a person or device or any other suitable force as would be apparent to one of ordinary skill in the art in view of the teachings herein.

### DETAILED DESCRIPTION

The following description of certain examples of the invention should not be used to limit the scope of the present invention. Other examples, features, aspects, embodiments, and advantages of the invention will become apparent to those skilled in the art from the following description, which is by way of illustration, at least one mode contemplated for carrying out the invention. As will be realized, the invention is capable of other different and obvious aspects, all without departing from the invention. Accordingly, the drawings and descriptions should be regarded as illustrative in nature and not restrictive.

Reconstitution Device

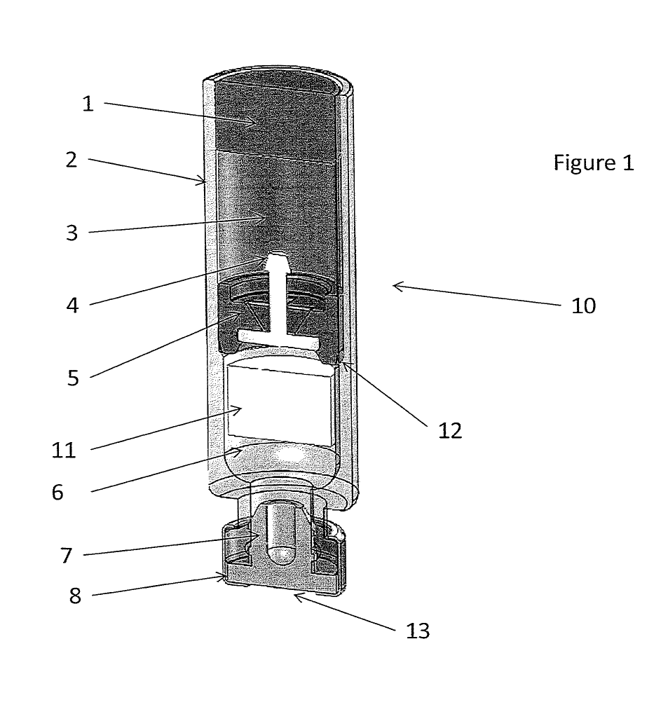

FIGS. 1-4 display a reconstitution cartridge that, when placed inside a delivery device, allows for changes in pressure or other force in one container to dislodge a valve that activates a pathway between the two containers. Once activated and once at least a portion of material has started to flow from one container to the other or after most or all of the material has transferred from one container to the other, then the reconstitution component that was activated will be compliant to movement. This allows for the reconstitution component to be physically compressed by the distal component due to a removal of an inner pin, valve, or plug that separately seals the two chambers separate. The valve component when in the sealing position also creates increased friction by not allowing the sealable component to be compliant inward. When the plug is activated, friction force is reduced allowing for easier movement along the axial distance of the cartridge. It will be appreciated that such a design would include but not be limited to being able to use any elongated cylinder chamber and this reconstitution component in order to create a dual chamber system that reconstitutes material or create a single chamber system that when added to another single chamber system can facilitate reconstitution of materials.

FIGS. 1-4 depict an exemplary reconstitution device (10) for reconstituting a drug component. Device (10) comprises a cartridge (2) defining a first chamber (3). The proximal end of cartridge (2) comprises a plunger (1). In the exemplary version, plunger (1) is constructed of rubber, but it will be appreciated that plunger (1) may be constructed of any suitable material as would be apparent to one of ordinary skill in the art in view of the teachings herein. A plug (4) is positioned distally from plunger (1) and is operable to selectively seal first chamber (3) from a second chamber (6), which holds drug component (11). Drug component (11) may comprise a solid or liquid material. Plug (4) is seated within sealing outer component and/or second plunger (5) such that when plug (4) is seated within sealable outer component (5), first chamber (3) and second chamber (6) are not in fluid communication. When plug (4) is dislodged from sealable outer component (5), then fluid communication between first chamber (3) and second chamber (6) is established. It will be understood that sealable outer component (5) may be shaped to complement plug (4) as seen in FIG. 1. For instance, sealable outer component (5) may be shaped to include an annular recess for holding plug (4) while plug (4) is inserted into sealable outer component (5), thereby increasing the amount of force required to remove plug (4) from sealable outer component (5). However, it will be understood that sealable outer component (5) may not necessarily need to be shaped to complement plug (4). Other suitable variations will be apparent to one of ordinary skill in the art in view of the teachings herein.

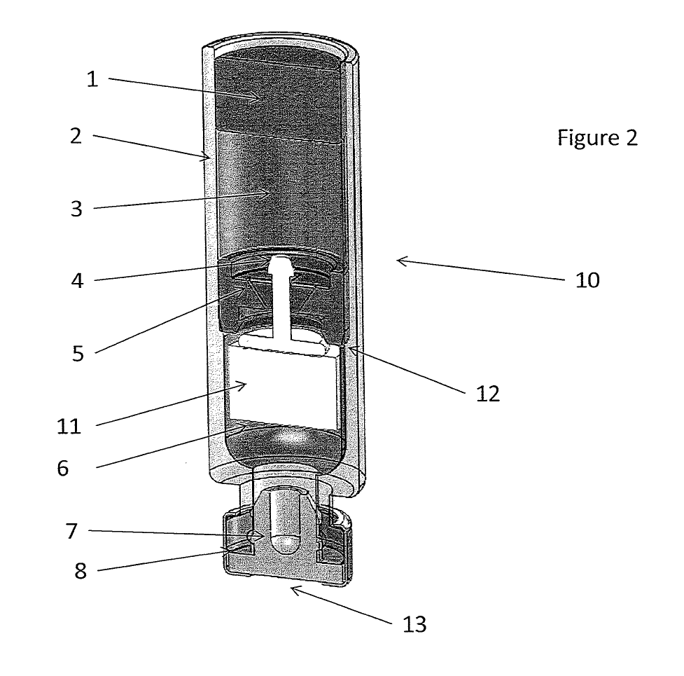

The activation of device (10) in FIGS. 1-4 is driven by applying a force to the rubber plunger (1) and then due to the force applied on the liquid or gas in the first chamber (3) there is an increase in pressure in the first chamber (3). In the exemplary version, force may be applied to a proximal region of plunger (1) toward plug (4). However, it will be understood that any suitable force may be applied to plunger (1) approaching from any suitable direction. Further, it will be appreciated that any suitable liquid or gas may be used in first chamber (3) as would be apparent to one of ordinary skill in the art in view of the teachings herein. This increase in force dislodges plug (4) from sealable outer component (5) resting between first chamber (3) and second chamber (6), which is shown, for example, in FIG. 2. Furthermore, as shown in the exemplary version, an annular lip (12) having generally a smaller radius than sealable outer component (5) prevents axial movement of sealable outer component (5) within cartridge (2) when plug (4) is seated within sealable outer component (5), which also has a smaller radius than plug (4). Annular lip (12) is operable to generally join or otherwise serve as an intermediary between first chamber (3) and second chamber (6). It will also be appreciated that first chamber (3) may have a wider diameter than second chamber (6) as seen in the illustrated version, though in some versions, first chamber (3) and second chamber (6) may have the same or similar diameters with annular lip (12) having a smaller diameter. Other suitable variations will be apparent to one of ordinary skill in the art in view of the teachings herein.

The dislodging of plug (4) allows fluid to flow from first chamber (3) into second chamber (6). Then, once the rubber plunger (1) reaches sealable outer component (5), it begins to push distally on sealable outer component (5). Sealable outer component (5) will move easier once plug (4) is dislodged due to plug (4) no longer obstructing the opening extending through the center of sealable outer component (5). Dislodging plug (4) from sealable outer component (5) allows sealable outer component (5) to inwardly compress as axial forces are applied to sealable outer component (5), which presses sealable outer component (5) against the slight ramp shape of annular lip (12). As a result, sealable outer component (5) applies less outward force against the walls of cartridge (2), resulting in less friction force between sealable outer component (5) and cartridge (2), thus allowing sealable outer component (5) to advance axially within cartridge (2). Sealable outer component (5) may also move axially past annular lip (12). Dislodging of plug (4) means that once plunger (1) reaches sealable outer component (5), it can more easily be moved axially along the direction of the cartridge (2). This could be done in a single or multiple motions. Also, cartridge (2) may be constructed of one piece or could be two pieces that are connected possibly but not necessarily via a connection mechanism or component as would be apparent by one of ordinary skill in view of the teachings herein.

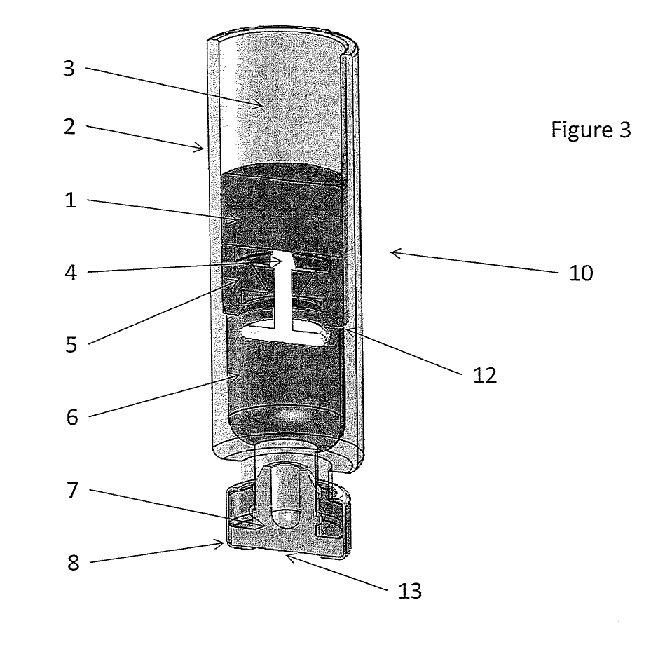

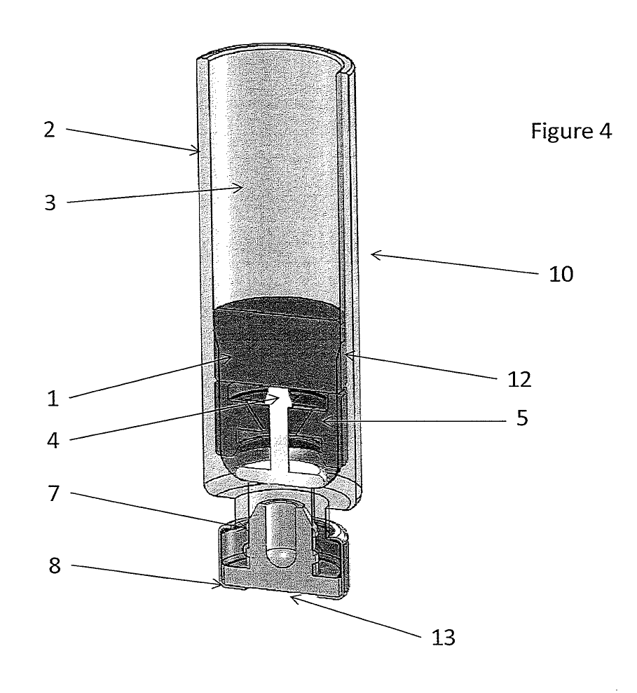

Once plug (4) is dislodged from sealable outer component (5), fluid from first chamber (3) flows to second chamber (6) to mix with drug component (11) as shown in FIG. 3. Thereafter, as plunger (1) is advanced axially, sealable outer component (5) is also advanced, which forces the fluid drug component (11) out of cartridge (2) through dispensing location (13), which is shown, for example, in FIG. 4.

In the exemplary version, a lyophilization stopper (7) may be used in conjunction with a crimped region (8) to prevent fluid from leaving cartridge (2) until desired. When the user is ready to allow fluid to leave cartridge (2), stopper (7) may be pierced, unplugged, dislodged, opened, etc., thereby allowing fluid to exit cartridge (2). It will be appreciated that in some versions, stopper (7) and crimped region (8) need not be used at all. Stopper (7) also may function to keep air and or bacterial or dust contaminants out of second chamber (6).

Also, in some exemplary versions, device (10) may be filled by first adding the liquid medicant to the chamber closest to the dispensing port (13). This liquid medicant can be lyophilized or if the material in this chamber is spray dried, can be added to the same chamber. Then once the lyophilization process is complete the liquid may be filled into the other chamber that is away from the dispensing port and the rubber stopper may be inserted for sealing. Additionally, the inner component in FIG. 1 comprising the outer sealing member (5) and a plug (4), could be added inside many different types of cartridges, auto-injectors, pen injectors, or other drug delivery devices, and or syringes. Adding one or more of these components comprising plug (4) and outer sealing member (5) would turn them into a mixing system with two or more chambers in a single container system or two or more compartments capable of mixing components together when joined by a connector.

Reconstitution Device with Sealing Rod

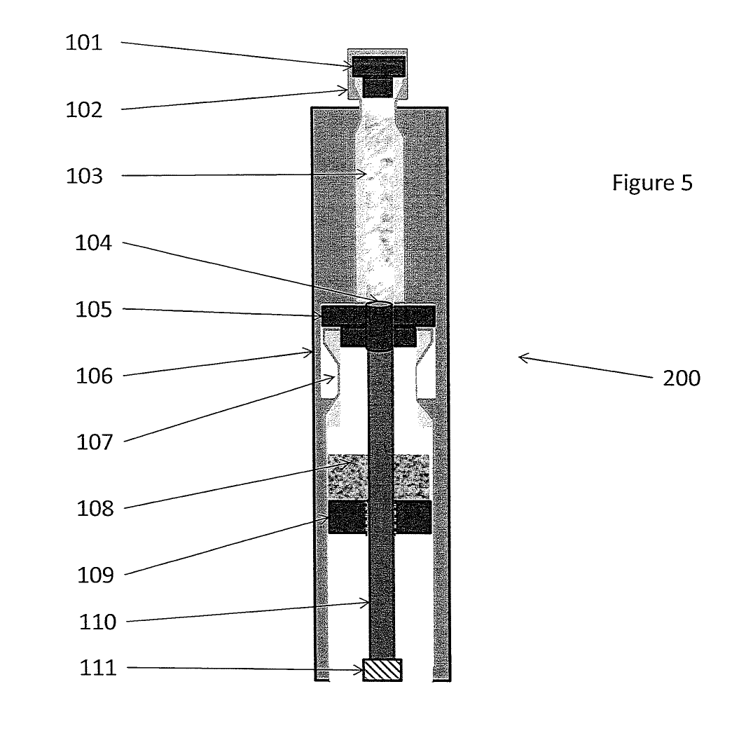

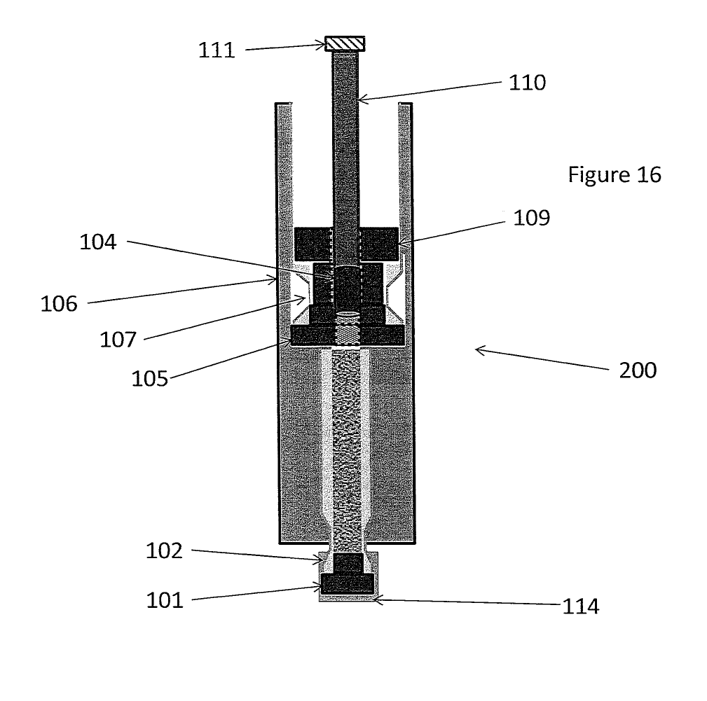

FIGS. 5-18 display a reconstitution device that contains a member inside a container or chamber which is withdrawn to allow for the opening of a passage between containers or chambers. Then, after mixed material is forced upward through the bottom container, the member inside the container will serve as the plunger which acts to force liquid through the dispensing end of the device. One exemplary feature of this type of system is not limited to but includes the ability to separate the container diameters from each other such that a lyophilized or spray dried section could be wide and short to facilitate the freeze drying process and such that the liquid medicant portion and the dispensing container could be long and skinny to facilitate accurate dosage with small volumes as dispensed from an external device of which the container set is loaded into. One exemplary feature of this reconstitution component that seals the two chambers apart is that the components themselves move axially throughout the syringe to allow for medicant dispensing after the valve seal integrity has been compromised to allow mixing.

As seen in FIG. 5, reconstitution device (200) comprises a holder device (106) operable to hold a container (107) and diluent container (103) therein. Diluent container (103) is operable to hold any suitable gas, liquid, or other fluid component as would be apparent to one of ordinary skill in the art. The distal end of diluent container (103) comprises a rubber stopper (101) held against diluent container (103) with a crimp member (102). Rubber stopper (101) in the exemplary version is operable to prevent fluid from exiting diluent container (103) prematurely. Rubber stopper (101) may be opened by a means of choice once the user is ready to force fluid from diluent container (103). While rubber stopper (101) of the exemplary version is constructed of rubber, it will be appreciated that any suitable material may be used as would be apparent to one of ordinary skill in the art in view of the teachings herein. An intermediate stopper (105) is positioned between diluent container (103) and container (107). Intermediate stopper (105) in conjunction with mini plunger head (104), which is positioned within a hole extending through the center of intermediate stopper (105), form a fluid seal between diluent container (103) and container (107). It will be appreciated that once mini plunger head (104) is removed from the center of intermediate stopper (105), fluid communication is established between diluent container (103) and container (107). In the exemplary version, mini plunger head (104) has a narrow cylindrical shape, but it will be appreciated that other shapes may be used as would be apparent to one of ordinary skill in the art. Mini plunger head (104) is connected to seal rod (110) which extends axially through container (107). As seal rod (110) is moved axially back or forth through container (107), mini plunger head (104) also moves. It will be appreciated that manipulation of seal rod (110) may dislodge mini plunger head (104) from intermediate stopper (105). Connector (111) may be controlled directly or through the use of a machine or other device to control movement of seal rod (110).

Also in FIG. 5, container (107) comprises a drug component (108), which may be in the form of a solid, liquid, gas, combination thereof, or any other suitable form as would be apparent to one of ordinary skill in the art. Drug component (108) in the exemplary version is formed as a ring around seal rod (110), but it will be understood that any suitable form for drug component (108) may be used as would be apparent to one of ordinary skill in the art in view of the teachings herein. A rubber plunger (109) is positioned on seal rod (110) and is operable to form a fluid seal between seal rod (110) and container (107). While the exemplary version shows plunger (109) constructed of rubber, any suitable material may be used as would be apparent to one of ordinary skill in the art.

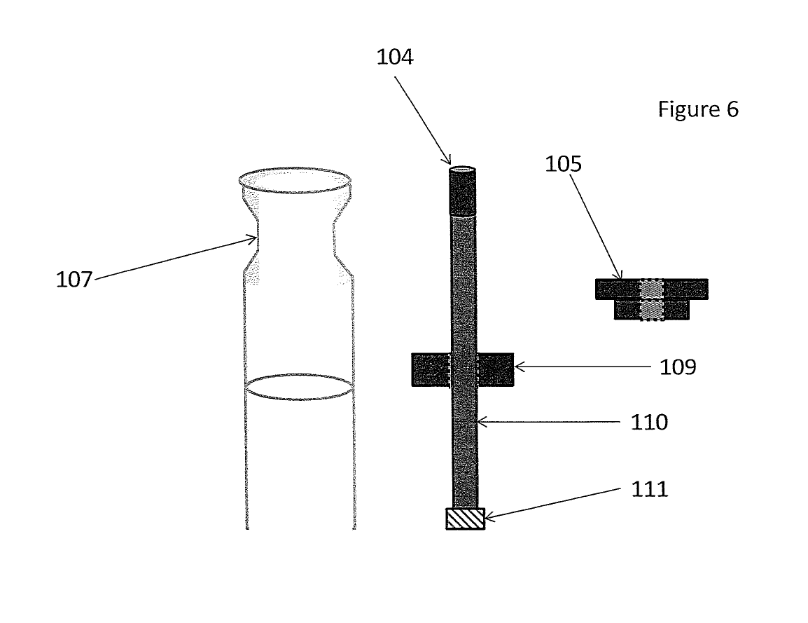

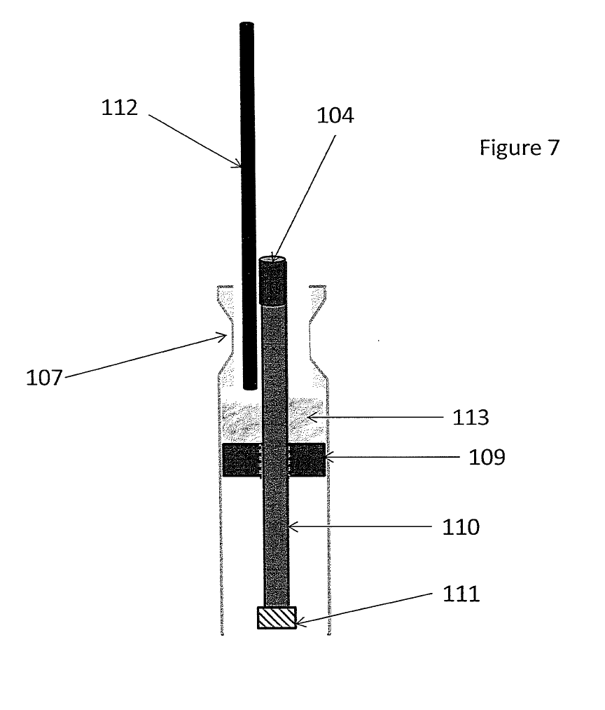

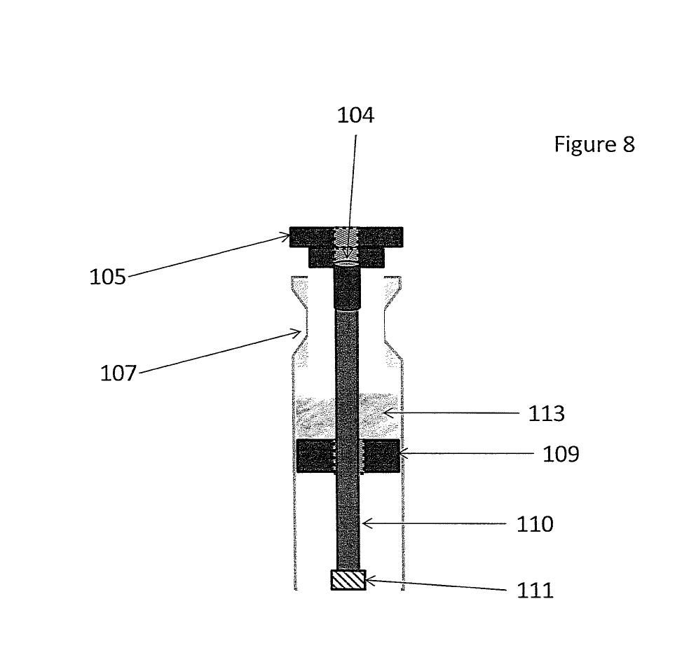

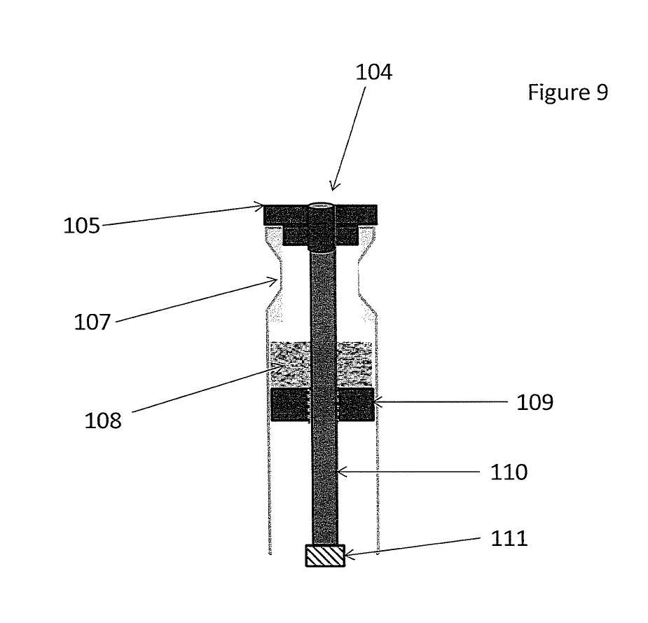

FIG. 6 shows components of device (200) separated, as might be envisioned prior to assembling device (200). FIG. 7 shows container (107) with plunger (109) and seal rod (110) extending through plunger (109) with container (107) ready to receive a drug (113). A fill rod (112) positioned off center from seal rod (110) is shown to deliver drug (113) to container (107). It will be understood that other suitable devices other than fill rod (112) may be used to deliver drug (113) to container (107) as would be apparent to one of ordinary skill in the art in view of the teachings herein. After drug (113) has be provided, FIG. 8 shows intermediate stopper (105) being fitted around mini plunger head (104) to seal container (107). It will be appreciated that intermediate stopper (105) may be constructed of two stacked stoppers where one of the two stoppers fits within container (107) and the other covers the opening of container (107). Other suitable configurations will be apparent to one of ordinary skill in the art in view of the teachings herein. FIG. 9 shows intermediate stopper (105) prior to sealing container (107) and drug (113) being lyophilized and compressed to form drug component (108). Seal rod (110) in the exemplary version extends longitudinally through plunger (109) and intermediate stopper (105), but it will be understood that seal rod (110) may be in communication with plunger (109) and intermediate stopper (105) in any manner as would be apparent to one of ordinary skill in the art in view of the teachings herein. It will be appreciated that other treatments and processes may be applied to drug (113) to form drug component (108) as would be apparent to one of ordinary skill in the art in view of the teachings herein.

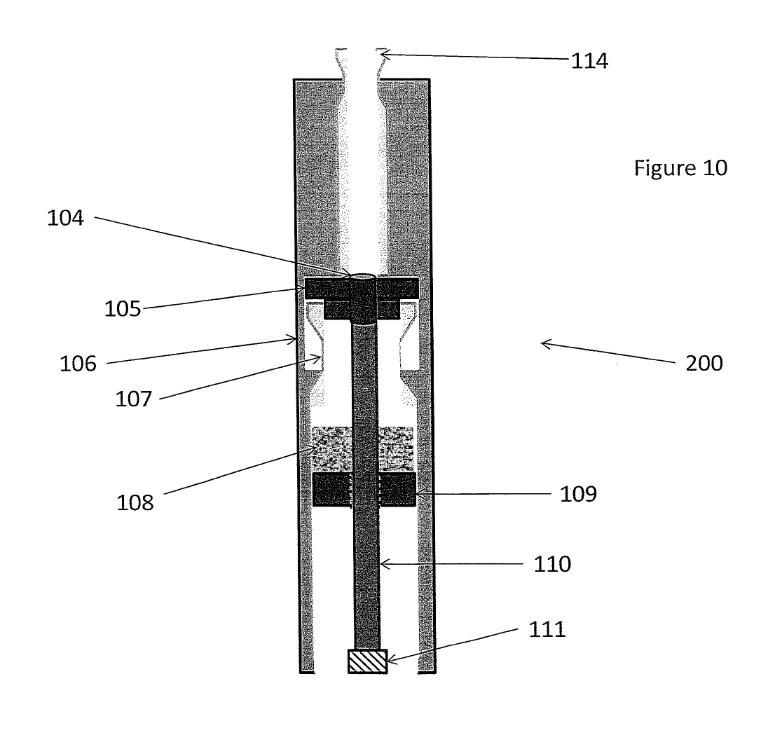

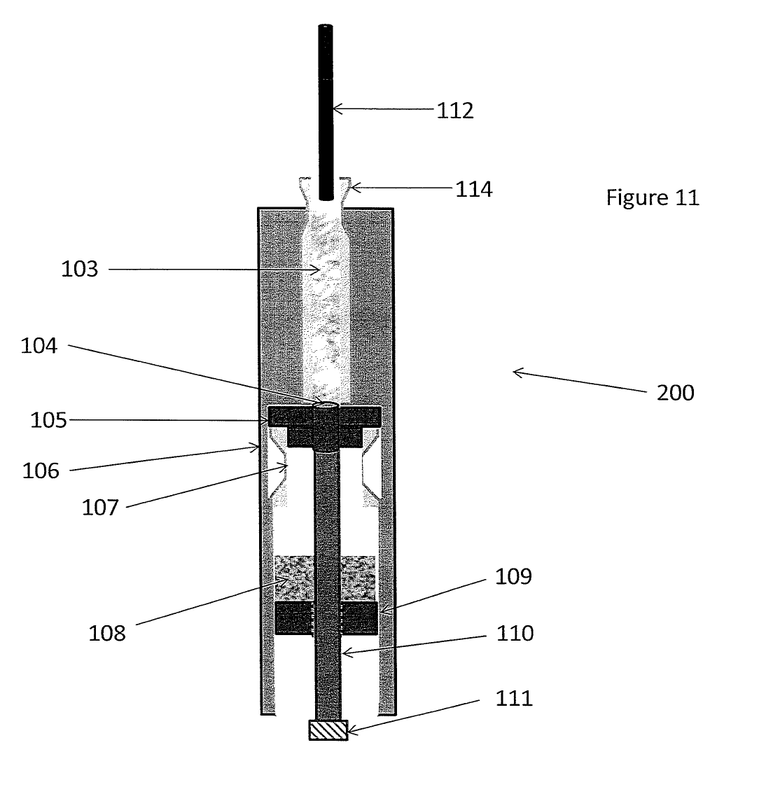

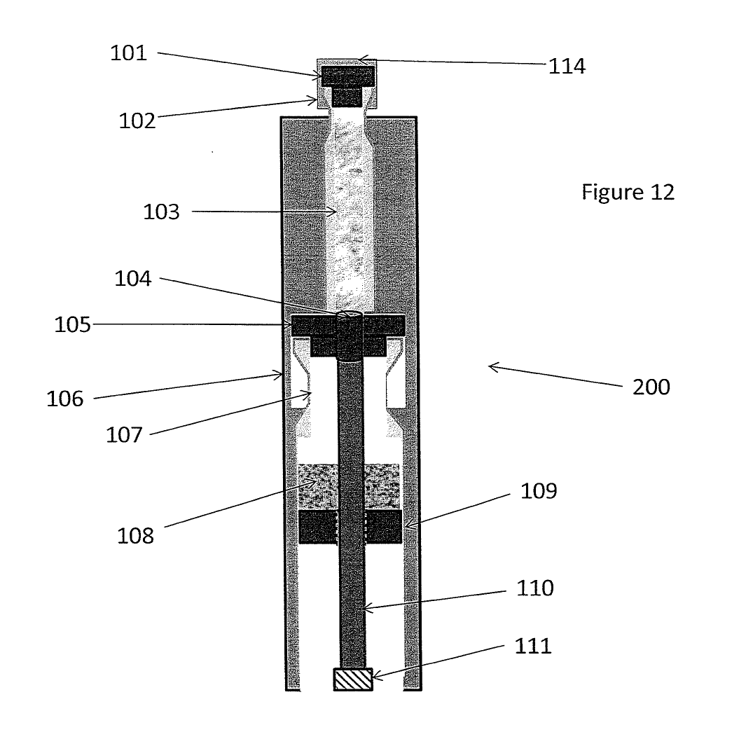

In FIG. 10, container (107) is placed in holder device (106). In FIG. 11, fill rod (112), which may be the same or different fill rod (112), is then used to deliver fluid into diluent container (103). While the exemplary version shows fill rod (112) being used to provide the fluid into diluent container (103), it will be appreciated that any suitable mechanism for delivering fluid may be used as would be apparent to one of ordinary skill in the art in view of the teachings herein. Rubber stopper (101) and crimp member (102) may be used to seal diluent chamber (103) as shown in FIG. 12.

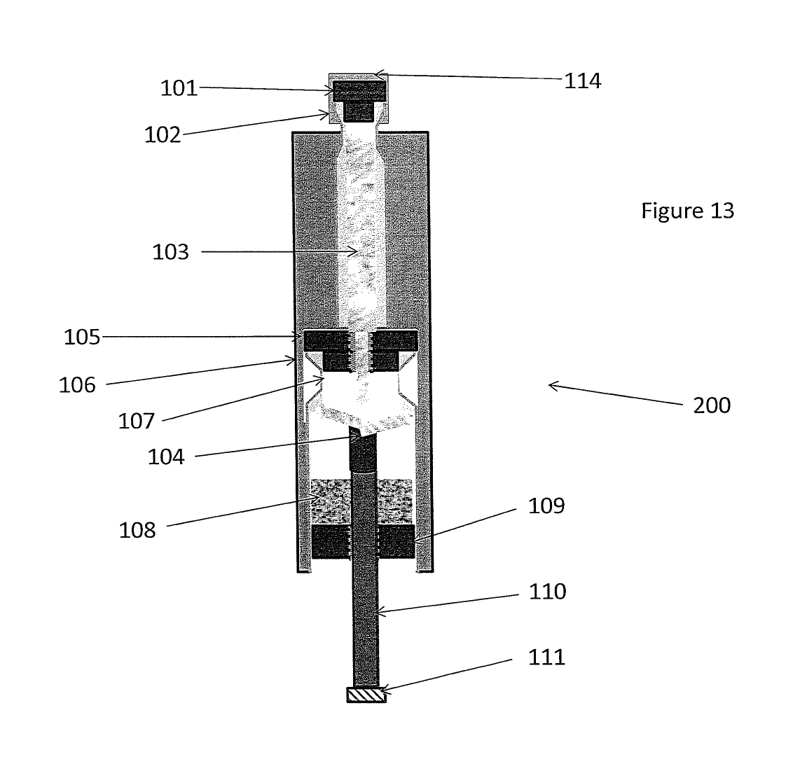

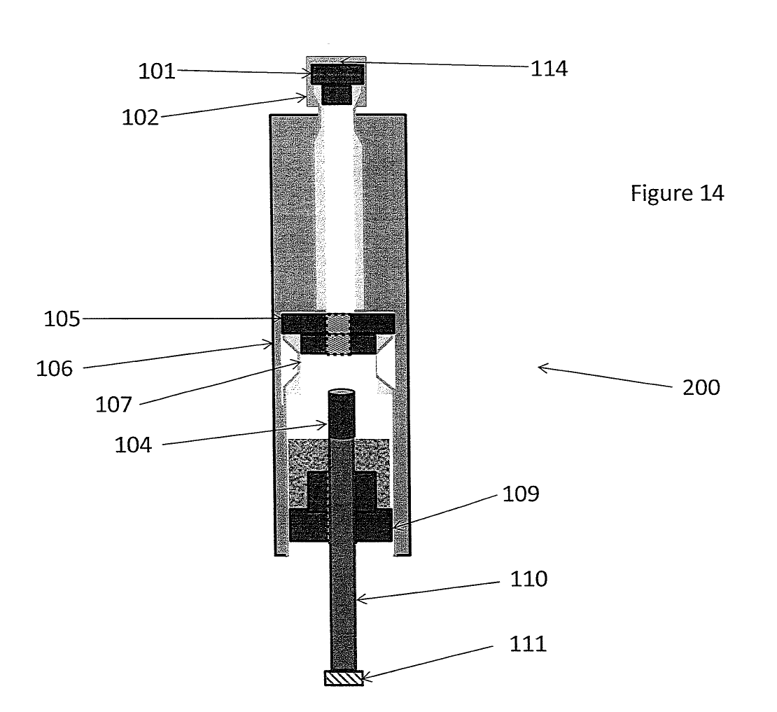

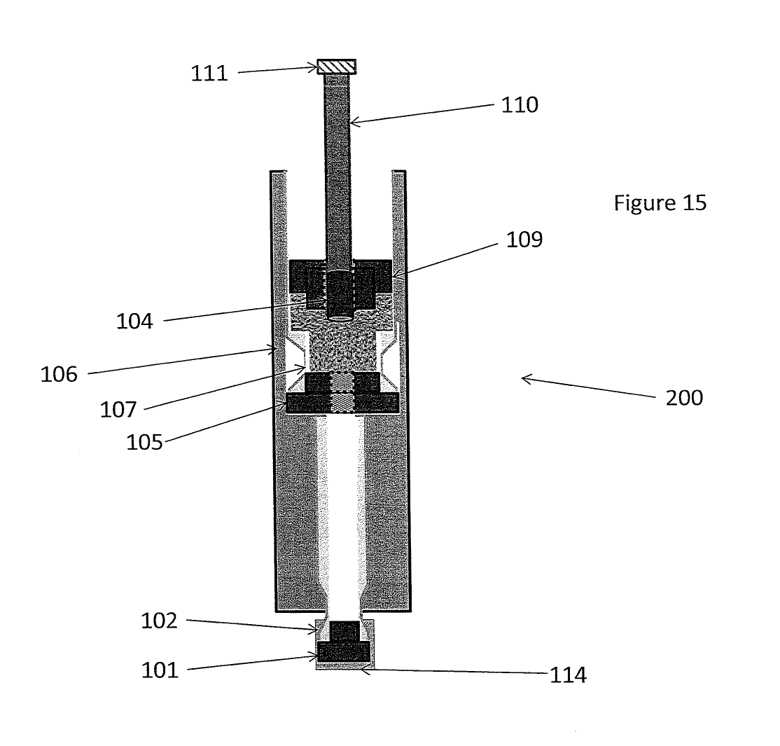

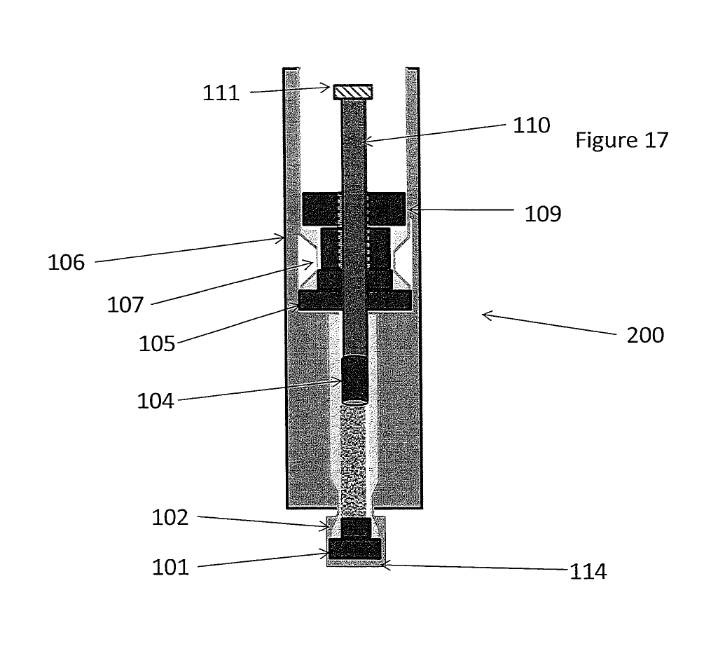

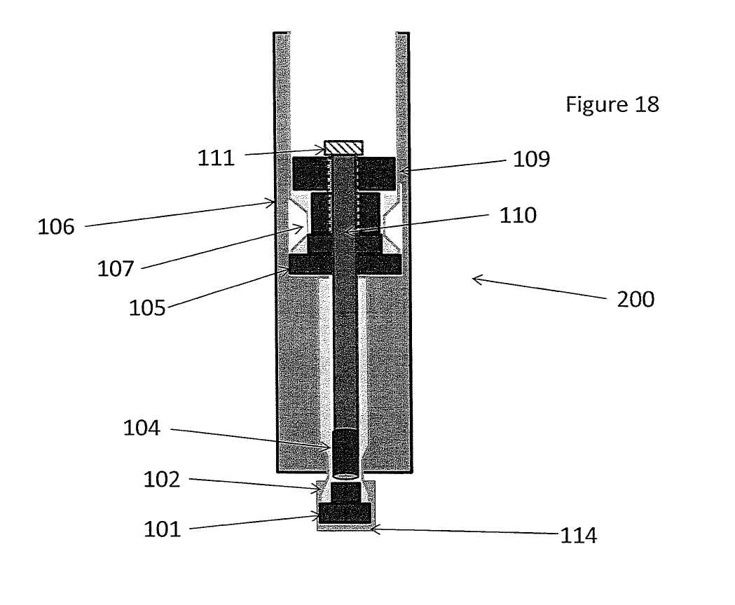

The activation of the device (200) as shown in FIG. 13 begins with the retraction of seal rod (110) by pulling on connector (111) that allows for seal rod (110) to be screwed backwards or pulled backwards. This action dislodges the mini plunger head (104) from the connection between the two containers (107, 103), allowing liquid in diluent container (103) to flow into container (107) when oriented in the appropriate direction. One could also envision a device that uses a mechanism of a plunger applied through diluent container (103) to dispel liquid into the bottom container (107) without the need for gravity driven orientation requirements. Once the liquid is mixed with the material in the bottom container (107), as shown in FIGS. 14-15, the bottom rubber plunger (109) will be pushed upward in order to push the mixed components up into diluent container (103) that originally housed the liquid. Seal rod (110) and mini plunger head (104) will then be used as a plunger to dispense liquid from the top container (103) out of dispensing port (114), which is shown in FIGS. 17-18.

Device (200) could comprise a single piece multi chamber vial or two or more vials placed together as shown via a connector. Due to seal rod (110), one exemplary feature of this device is that it would require the physical movement of a device or user to enable reconstitution. A side load or other strong force may still knock seal rod (110) out of place but seal rod (110) should impart a strong seal in at least the static storage but possibly also while under some moving storage condition. Pressure and/or other forces would need to exceed the force holding the seal in place in order to dislodge the seal and allow for mixing, making this design very robust. This vial system, due to seal rod (110), may be filled off center of the opening or alternatively the rod could be designed in a half moon shape or other configuration to allow for an on center filling of the components into the vial with the rod.

Reconstitution Device with an Attachable Sealing Rod

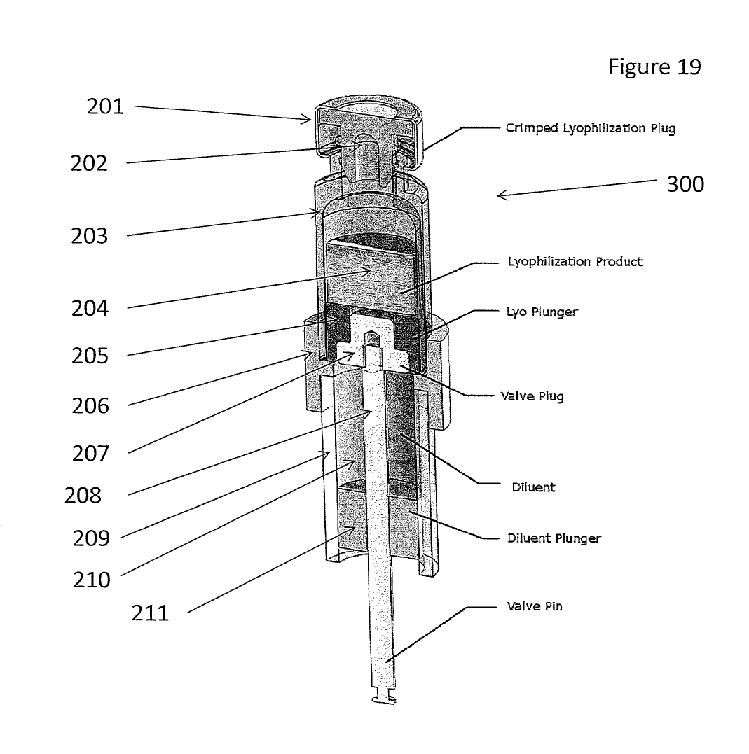

FIGS. 19-26 depict another exemplary version of a reconstitution device (300). Reconstitution device (300) comprises a cartridge (203), a connector (206), and a diluent container (209) where connector (206) joins cartridge (203) and diluent container (209). As seen in FIG. 19, the distal end of cartridge (203) comprises a cap (201). Cap (201) may be crimped or otherwise suitably retained against cartridge (203). Stopper (202) is secured to cartridge (203) with cap (201), and stopper (202) is operable to plug cartridge (203) until fluid held within cartridge (203) is ready for use or dispensing.

Cartridge (203) in the exemplary version holds a drug component (204), which may comprise a lyophilized drug component. In other versions, it will be appreciated that drug component (204) may be any suitable drug component having any suitable form as would be apparent to one of ordinary skill in the art in view of the teachings herein.

Cartridge (203) further comprises a ring plunger (205) defining an opening extending through ring plunger (205). In the exemplary version, ring plunger (205) comprises rubber material, but it will be appreciated that ring plunger (205) may be constructed of any suitable material as would be apparent to one of ordinary skill in the art in view of the teachings herein. As stated above, connector (206) joins cartridge (203) and diluent container (209), but it will be appreciated that cartridge (203) and diluent container (209) may comprise a unitary construction, integrally formed, having multiple pieces, or any other suitable variation. It will be appreciated that cartridge (203) may be constructed of two separate, single-chambered cartridges connected via a bridge or a sleeve in one of the cartridges walls or a double chambered cartridge separated by, for example, a rubber stopper barrier as one piece of glass or plastic outer wall. Other suitable configurations for cartridge (203) will be apparent to one of ordinary skill in the art in view of the teachings herein.

A plug (207) is operable to be seated within ring plunger (205), and rod (208) is connected to plug (207). Rod (208) is removably connected to plug (207). In the exemplary version, for example, the center of plug (207) may comprise threads such that rod (208), having complementary threads may be connected to plug (207) by turning rod (208). Thus, when the user moves rod (208), accordingly, plug (207) also moves. It will be appreciated that rod (208) may be attached to plug (207) at any suitable time including, but not limited to after diluent is placed in diluent chamber (210) or after drug component (204) is placed in cartridge (203). Once plug (207) is removed from ring plunger (205), cartridge (203) establishes fluid communication with diluent chamber (210) of diluent container (209). It will be appreciated that rod (208) and plug (207) may be connected in any suitable way as would be apparent to one of ordinary skill in the art in view of the teachings herein. It will be understood that diluent container (210) may hold any suitable type of diluent as would be apparent to one of ordinary skill in the art in view of the teachings herein.

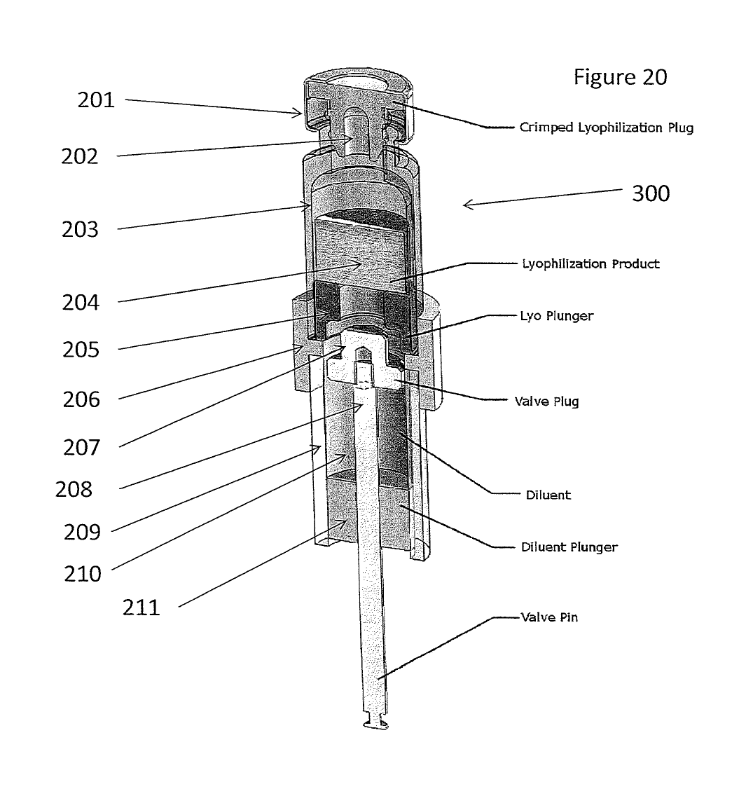

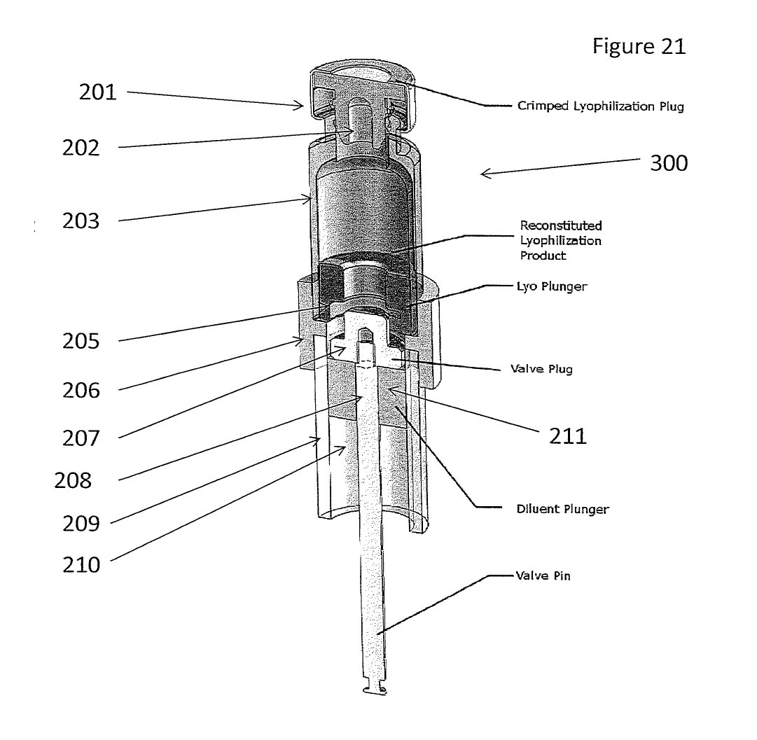

FIGS. 19-26 show an exemplary sequence of use of reconstitution device (300). FIG. 20 shows reconstitution device (300) with rod (208) slightly retracted. It will be understood that such retraction may be caused by the user or by any other suitable means. As a result of plug (207) being removed from ring plunger (205), diluent may be transferred from diluent chamber (210) to cartridge (203). As shown in FIG. 21, the transfer of diluent may be caused by the advancement of diluent plunger (211) through diluent chamber (210). In other versions, it will be appreciated that any suitable means for transferring diluent may be used as would be apparent to one of ordinary skill in the art in view of the teachings herein. As diluent is transferred to cartridge (203), drug component (204) is reconstituted and ready for use.

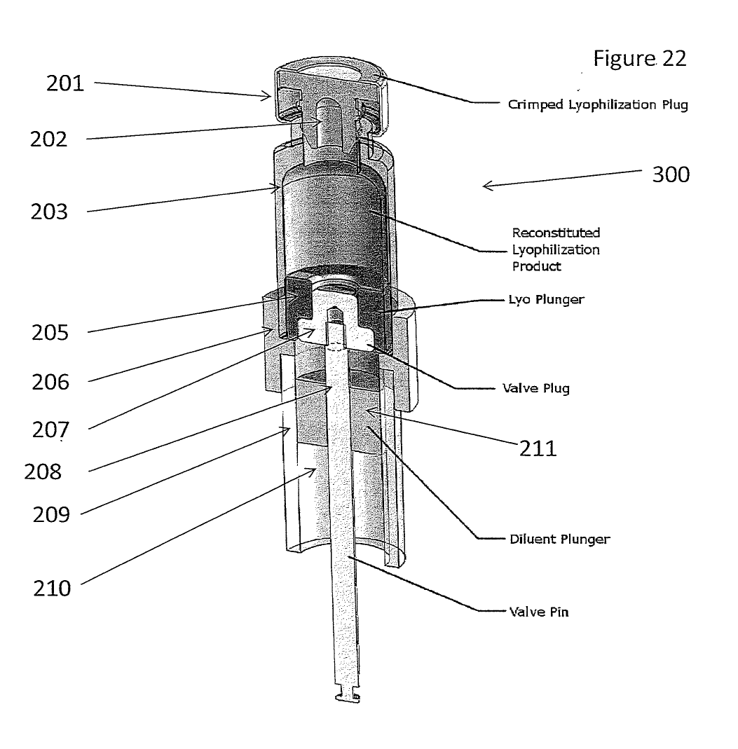

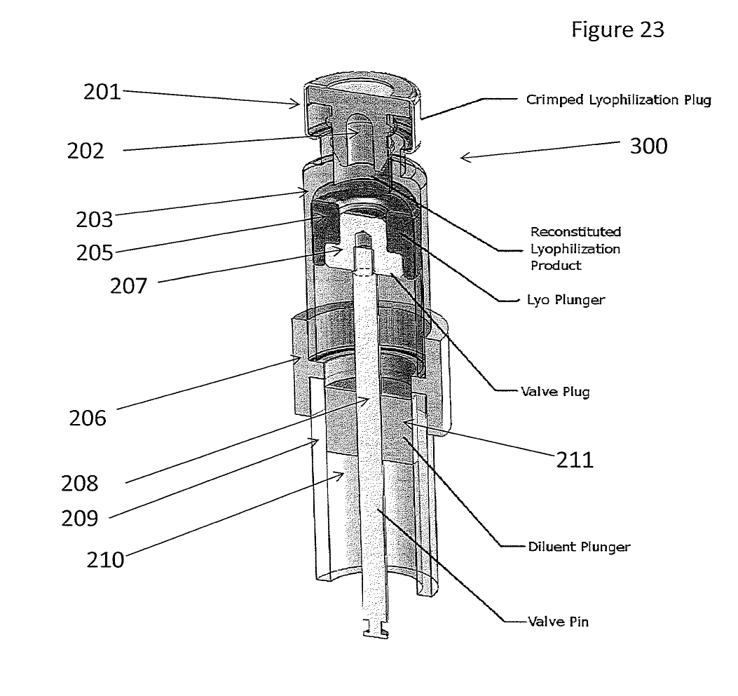

Moving now to FIG. 22, plug (207) has been placed back into ring plunger (205). As a result, the reconstituted drug component (204) is kept separate from atmospheric air. It will be appreciated that plug (207) and ring plunger (205) are operable to form a fluid tight seal. FIG. 23 then shows plug (207) being advanced through cartridge (203) with ring plunger (205). Essentially, plug (207) and ring plunger (205) form a plunger such that as they advance through cartridge (203), the reconstituted drug component (204) is dispensed.

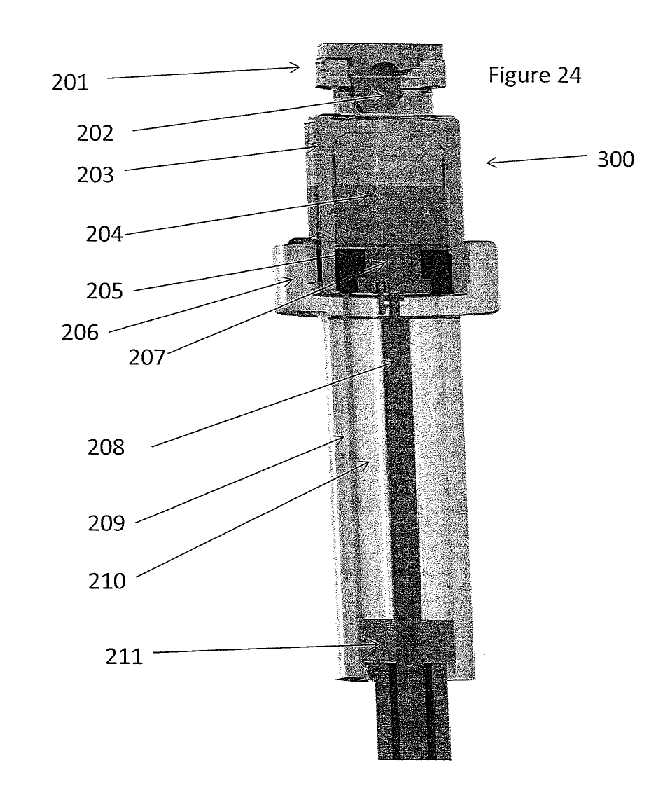

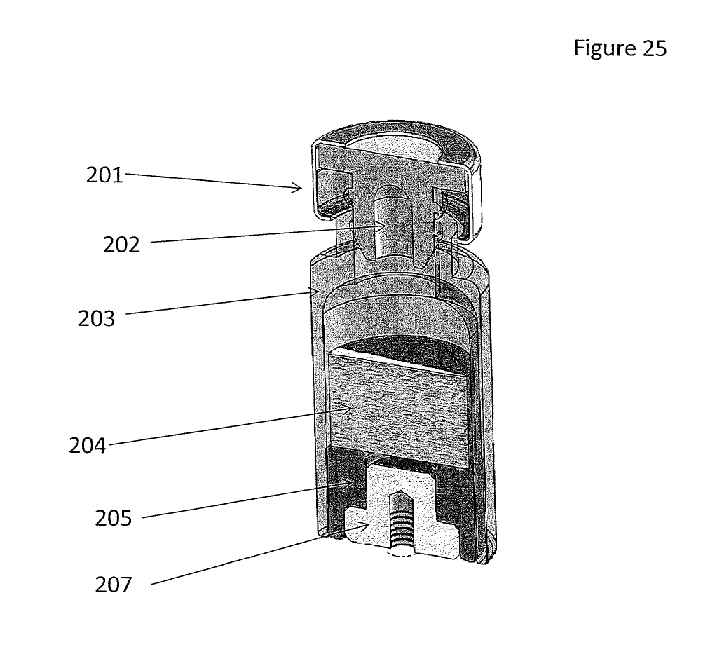

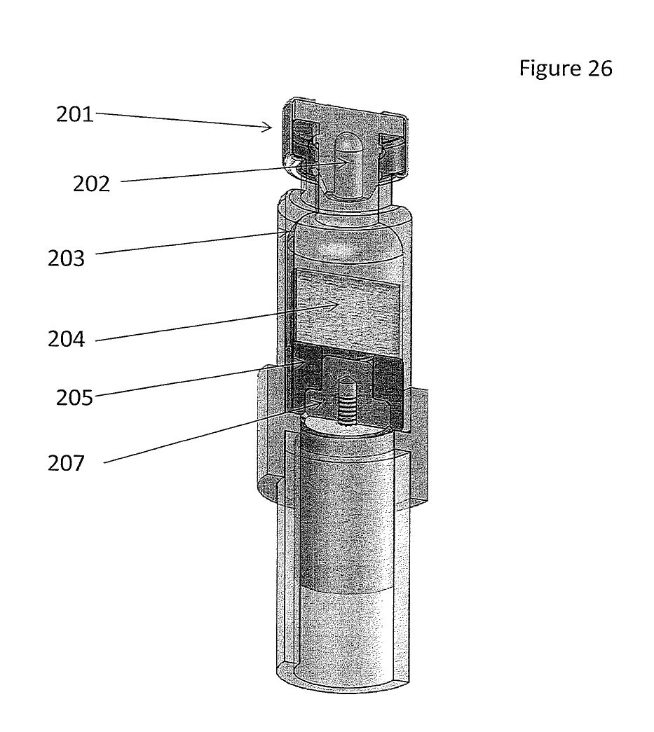

FIG. 24 shows an exemplary version where diluent container (209) defines a built in opening such that cartridge (203) may lock into diluent container (209). As will be apparent to one of ordinary skill in the art, other suitable ways of connecting diluent container (209) and cartridge (203) may be used. FIG. 25 shows a cross sectional view of cartridge (203). FIG. 26 shows an exemplary configuration for cartridge (203) and diluent container (209) for filling diluent chamber (210) with a diluent. Other suitable configurations may be used as would be apparent to one of ordinary skill in the art.

One exemplary feature of reconstitution device (300) would be faster lyophilization time due to more conductive surface area touching a lyophilization tray. In the initial state the rod (208) is connected to plug (207). Then the valve pin or rod (208) is pulled backward to dislodge plug (207) and allows for reconstitution to take place. Diluent plunger (211) is pressed forward to expel liquid around plug (207) until the final push against plug (207) urges almost all of the reconstituted material back into the front chamber of cartridge (203). This cartridge (203) can then be further expelled by forward compression as needed to administer dose or mixed drug. It will be appreciated that ring plunger (205) is held in place by a lip, ledge, or change in diameter which does not allow ring plunger (205) to retract backwards, only forwards after diluent plunger (211) has fully advanced.

Having shown and described various embodiments of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, embodiments, geometrics, materials, dimensions, ratios, steps, and the like discussed above are illustrative and are not required. Accordingly, the scope of the present invention should be considered in terms of any claims that may be presented and is understood not to be limited to the details of structure and operation shown and described in the specification and drawings.

I/We claim:

1. An apparatus comprising:
(a) a body configured to hold one or more medical substances therein, wherein the body defines a longitudinal axis extending therethrough;
(b) a plunger positioned within a portion of the body, wherein the plunger is configured to axially advance along the longitudinal axis of the body, wherein the plunger defines an opening extending therethrough; and
(d) an occlusion configured to extend through at least a portion of the opening of the plunger such that the plunger and the occlusion are operable to fluidly divide the body, wherein the plunger is configured to exert a first outward force against the body with the occlusion inserted in at least a portion of the opening, wherein the plunger is configured to exert a second outward force against the body when at least a portion of the occlusion has been removed from the opening.

2. The apparatus of claim 1, wherein the occlusion comprises a plug.

3. The apparatus of claim 2, wherein the plug is configured to dislodge from the plunger in a single direction.

4. The apparatus of claim 1, further comprising a rear plunger configured to axially advance to urge the occlusion from the plunger.

5. The apparatus of claim 4, wherein the rear plunger is further configured to urge the plunger axially.

6. The apparatus of claim 1, wherein a portion of the body is defined by a first diameter, wherein another portion of the body is defined by a second diameter, wherein the first diameter is larger than the second diameter.

7. The apparatus of claim 6, wherein the plunger is configured to axially advance from the portion of the body defined by the first diameter to the portion of the body defined by the second diameter.

8. The apparatus of claim 1, wherein the occlusion comprises a longitudinally extending rod in communication with the plunger.

9. The apparatus of claim 8, wherein the longitudinally extending rod is configured to screw into the plunger.

10. The apparatus of claim 1, wherein a portion of the body is filled with one of a lyophilized substance, powder substance, spray dried substance, or solid medicament.

11. An apparatus for reconstituting a medical substance comprising:
(a) a body operable to hold a diluent, the body defining a longitudinal axis extending therethrough, wherein the body defines a first body diameter;
(b) a first plunger configured to axially advance within the body, wherein the first plunger is configured to form a barrier within the body; and
(c) a second plunger positioned within the body axially spaced from the first plunger, wherein the second plunger is configured to assume a first state and a second state, wherein the second plunger in the first state maintains an axially stationary position within the body, wherein the second plunger in the second state is operable to axially advance within the body, wherein the second plunger is operable to be activated to switch from the first state to the second state.

12. The apparatus of claim 11, further comprising a plug selectively insertable into the second plunger, wherein the plug and the second plunger are configured to form a barrier within the body, wherein the plug is configured to be removed from the second plunger to activate the second plunger.

13. The apparatus of claim 12, wherein the second plunger is shaped to form an annular recess that complements the plug, wherein the annular recess is configured to retain the plug.

14. The apparatus of claim 11, wherein the body defines a second body diameter, wherein the second body diameter is smaller than the first body diameter.

15. The apparatus of claim 11, wherein the second plunger is configured to allow fluid flow therethrough when activated to assume the second state.

16. The apparatus of claim 11, further comprising a plug extending longitudinally through the first plunger and the second plunger.

17. An apparatus comprising:
(a) a cartridge body operable to hold a diluent;
(b) an occlusion positioned longitudinally through the cartridge body; and
(b) a first plunger in communication with the cartridge body, wherein the first plunger defines an opening configured to receive the occlusion, wherein the first plunger is frictionally held within the cartridge body, wherein the first plunger is movable between first state and a second state, wherein the first plunger in the first state fluidly blocks a portion of the cartridge body, wherein the first plunger in the second state allows at least a portion of fluid to flow through the opening of the first plunger.

18. The apparatus of claim 17, further comprising a second plunger positioned axially spaced apart in relation to the first plunger, wherein the second plunger is configured to urge the first plunger axially.

19. The apparatus of claim 18, wherein the second plunger is operable to urge the first plunger axially while fluid flows through the first plunger.

20. The apparatus of claim 17, further comprising a filling port operable to deliver a material to the cartridge body, wherein the filling port is longitudinally offset from the occlusion.
